(19) United States
(12) Patent Application Publication
(10) Pub. No.: US 2013/0249120 A1
(43) Pub. Date: Sep. 26, 2013

(54) CARBURETOR FUEL FILTER

(71) Applicant: Michael P. Burns, Millington, MI (US)

(72) Inventor: Michael P. Burns, Millington, MI (US)

(73) Assignee: WALBRO ENGINE MANAGEMENT, L.L.C., Tucson, AZ (US)

(21) Appl. No.: 13/428,327

(22) Filed: Mar. 23, 2012

(51) Int. Cl. F02M 37/22; B23P 17/00

(52) U.S. Cl. 261/4; 29/525

(57) ABSTRACT

An on-board fuel filter for a carburetor includes a filter element made from a non-metallic material. The material can be a polymeric material and may be a woven or a non-woven material. The fuel filter may be adapted to have an interference fit with a fuel passage of the carburetor and constructed so that the fuel filter is substantially not plastically deformed by the interference fit. Filter elements may be cut from a sheet of polymeric material and aligned with a fuel passage opening in a body of the carburetor while being cut.

### TECHNICAL FIELD

The present disclosure relates generally to a fuel filter element for use with a carburetor.

### BACKGROUND

Carburetors for use with combustion engines sometimes include on-board fuel filtration that works in conjunction with one or more other types of filtration along a fuel path from a fuel storage tank to the engine. Such on-board filtration may include a filter element that is assembled with and provided as part of the carburetor assembly. Though fuel is often filtered prior to reaching the carburetor, on-board filtration can provide an additional safeguard against particles in the fuel that could adversely affect the operation of jets, orifices, valves or other components in the carburetor if left in the fuel.

### SUMMARY

In accordance with one embodiment, a carburetor is provided that includes a fuel inlet and a metering system. The metering system includes a metering valve arranged downstream from the fuel inlet. The carburetor also includes a non-metallic filter element supported in a fuel passage of the carburetor.

In accordance with another embodiment, a method of making a carburetor is provided. The method includes the steps of providing a substantially flat fuel filter and pressing the fuel filter into a fuel passage opening of the carburetor. The flat fuel filter is sized to have an interference fit with the fuel passage opening, and the fuel filter is substantially not plastically deformed by the interference fit.

### BRIEF DESCRIPTION OF THE DRAWINGS

The following detailed description of preferred embodiments and best mode will be set forth with reference to the accompanying drawings, in which:

FIG. 1 is a cross-sectional schematic view of a carburetor with a fuel filter in a fuel passage, according to one embodiment; and

FIG. 2 is a cross-sectional view of a portion of the carburetor of FIG. 1, showing a fuel filter being cut from a sheet of material so that it is aligned with the fuel passage.

### DETAILED DESCRIPTION OF PRESENTLY PREFERRED EMBODIMENTS

As described below, a fuel filter for use as part of a carburetor may include a filter element made from a non-metallic material, such as a woven or non-woven polymeric material. While generally described in conjunction with the figures as a filter located between an on-board fuel pump and a metering valve, it should be recognized that the filter may be located anywhere along a fuel passage or passages of the carburetor, with or without a fuel pump. It is noted that the figures are not to scale, with certain features exaggerated and others minimized or not shown.

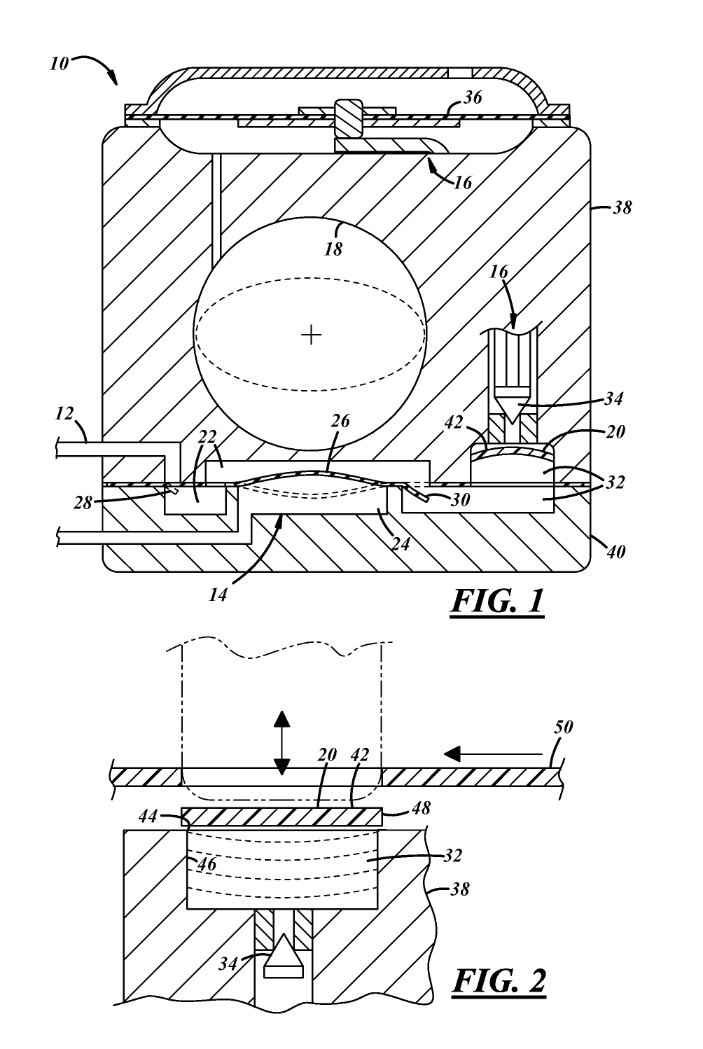

Referring in more detail to the drawings, FIG. 1 is a cross-sectional schematic view of a carburetor 10 with an on-board fuel filter, according to one embodiment. The carburetor 10 includes a fuel inlet 12, a fuel pump 14, a metering system 16, and an air passage 18 arranged along a fuel flow path between a fuel storage tank or other fuel source and a combustion engine (not shown). A fuel filter 20 is located between the fuel pump 14 and the metering system 16 in the illustrated example. The carburetor 10 receives fuel at fuel inlet 12 from the fuel storage tank or other source, which may or may not be a pressurized source. In this embodiment, the fuel pump 14 provides a pressure differential that causes fuel to flow from the fuel source to the carburetor 10. Fuel pump 14 also provides fuel to the metering system 16 for metered fuel delivery to the air passage 18.

The fuel pump 14 in this example is a diaphragm fuel pump, including a fuel chamber 22 and a pulse chamber 24, separated by a diaphragm 26. Alternating high and low pressure pulses are provided at the pulse chamber 24 via connection to an engine crankcase or other source. Diaphragm 26 moves back and forth (up and down in FIG. 1) accordingly in response to the pressure pulses. A subatmospheric pressure pulse in chamber 24 causes the diaphragm 26 to move in a direction (shown as a dashed line) that increases the volume of the fuel chamber 22, causing fuel to flow into the fuel chamber 22 from fuel inlet 12 through inlet check valve 28 and closing outlet check valve 30. A superatmospheric pressure pulse in chamber 24 causes the diaphragm 26 to move in an opposite direction that decreases the volume of the fuel chamber 22, causing fuel to flow into fuel passage 32 from fuel chamber 22 through outlet check valve 30 and closing inlet valve 28. Fuel passage 32 is thereby supplies with fuel for use by the metering system 16, which includes a metering valve 34 and a metering diaphragm 36 that work together to provide metered doses of fuel from fuel passage 32 to the air passage 18 for mixing and delivery to an engine.

The fuel filter 20 is located along the fuel flow path from the fuel source to the engine. In the illustrated embodiment, it is located along the fuel flow path between the fuel inlet 12 and the metering valve 34, the metering valve 34 being located downstream from the fuel inlet 12. More particularly, the fuel filter 20 is located in fuel passage 32 between the fuel chamber 22 of the fuel pump 14 and the metering valve 34. As used herein, a fuel passage is any port, conduit, line, opening, aperture, recess, or other element along which fuel flows on its way from the fuel source to the engine. The illustrated carburetor 10 includes a number of fuel passages, including fuel inlet 12, fuel chamber 22, fuel passage 32, and several other undesignated fuel passages such as those associated with the metering system 16. Some fuel passages include a plurality of smaller passages. For example, as is apparent from FIG. 1, the pump chamber 22 and the fuel passage 32 each include portions formed in both first and second carburetor bodies 38, 40.

The illustrated fuel filter 20 and fuel passage 32 together form an interference fit—i.e., the width or diameter of fuel filter 20 is slightly larger than the fuel passage 32 before assembly. Thus the fuel filter 20 may be substantially flat prior to assembly and assume a slightly curved shape after assembly, as shown. The fuel filter 20 includes a filter element 42. In one embodiment, the fuel filter 20 consists essentially of the filter element 42. In other embodiments, the fuel filter 20 may include additional elements such as a housing, frame, another feature that supports the filter element 42 in the particular fuel passage, or some other element that provides additional functionality to the fuel filter 20. As used herein, a filter element is a component with opposite surfaces through which fluid can flow from one surface to the other and is characterized by its ability to remove unwanted or unnecessary components from the fluid, such as particles larger than a certain size or chemical components. In one embodiment, the filter element 42 is a mechanical filter element, meaning that it removes particles larger than a certain size from the fluid that passes therethrough. For example, a mechanical filter element with a plurality of 35 micron holes or pores formed therethrough may remove particles larger than 35 microns from the fluid passing through the filter element.

In one embodiment, the fuel filter 20 includes a non-metallic filter element 42. As used herein, a non-metallic filter element is a filter element in which metal is not a majority constituent. For example, the filter element 42 may be a polymeric filter element. A polymeric filter element may be constructed from any suitable polymeric material, such as a semi-crystalline plastic. Semi-crystalline plastics may provide exceptional solvent resistance properties, which are useful along a fuel flow path that subjects the filter element 42 to solvents such as gasoline, ethanol, or other hydrocarbon fuels. Some non-limiting examples of suitable polymeric materials include certain polyamides, polyesters, fluoropolymers, polyacetals, polyethylenes, or alloys or copolymers thereof. Some more specific examples include nylon 6,6, polytetrafluoroethylene (PTFE), fluorinated ethylene propylene (FEP), polyethylene terephthalate (PET) (e.g., Mylar by Dupont), polyoxymethylene (POM), low-density polyethylene (LDPE), or ethylene vinyl alcohol (EVOH). Polymeric materials may optionally include fillers or modifiers such as colorants, stabilizers, reinforcements, electrical conductors, etc.

The filter element 42 may be a woven material or a non-woven material. For example, one particular example of a suitable filter element 42 is a filter element constructed from a woven nylon 6,6 material. It has been found that a woven nylon 6,6 filter element with a nominal 35 micron rating allows about the same flow rate of fuel therethrough as a woven stainless steel filter with a nominal 44 micron rating installed in the same size fuel passage. Thus it is possible in some cases to achieve better fuel filtration with a non-metallic filter element than with a metal filter element. This may be due, at least in part, to the ability to weave smaller polymeric fibers together to form the filter element material than is possible with certain metal fibers. In other words, the facial area of a polymeric filter element may include less solid material between flow openings than a metal filter element with the same size flow openings. Of course, other factors may play a role.

In another embodiment, the filter element 42 is formed from a non-woven material. For example, the filter element may be cut or otherwise formed from a film or other sheet stock material by piercing holes or forming pores of the desired size through the material while in sheet form. Laser cutting, machining, punching, calendaring, or another suitable technique may be used to form such holes or pores through the material. Some techniques, such as laser cutting, may be useful to enable changes in the size, number, or pattern of the holes or pores without the expense and complication of new tooling, for example.

With reference to FIG. 2, a method of making a carburetor including a fuel filter such as those described above is also disclosed. In one embodiment, the method includes providing fuel filter 20 in substantially flat form and sized to have an interference fit with the fuel passage 32 and/or a fuel passage opening 44 of the carburetor. The method further includes pressing the fuel filter 20 through opening 44 and into fuel passage 32 such that the fuel filter 20 is substantially not plastically deformed by the interference fit. In other words, though the filter 20 may assume a more curved shape when subjected to the interference fit, it may substantially return to its flat shape if removed from the fuel passage 32. Substantial plastic deformation, as used here, refers to generally non-reversible deformation that occurs at the time of installation. Substantial plastic deformation generally results in visible creases, folds, or bends in the material that do not go away after the applied strain is removed. Plastic deformation that may occur during service life due to stress-relaxation or creep is not included in the substantial plastic deformation as used here.

By way of example, it has been found that a flat fuel filter 20 consisting of a filter element 42 made from certain polymeric materials can be configured to have an interference fit with the fuel passage 32 sufficient to retain the filter element 42 in the passage 32 at the desired location without permanently deforming the filter element 42. That is to say that the filter element material has a characteristic elastic region below a critical strain value, and the interference fit is such that the filter element material is subjected to an amount of strain less than the critical strain value. Above the critical strain value, the material plastically deforms and will not return to its original shape. In one particular example, an interference fit of about 0.15-0.41 mm with a round polymeric filter element (diameter=8.20 mm) has been found to sufficiently retain the filter in the desired passage (diameter=7.79-8.05 mm) without substantial plastic deformation so that, if removed just after installation, the filter element returns to its original diameter and can be reinstalled with the expectation of about the same retention force.

This characteristic may be useful for a variety of reasons. For example, it may reduce manufacturing scrap by allowing reuse of the filter element 42 if installed crooked or otherwise incorrectly because it retains its flat configuration. If the filter is significantly plastically deformed during installation, filter retention force could be too low to withstand use over time, which may include hot and cold thermal cycling, vibration, or other conditions that tend to dislodge fuel filters. Installing the filter so that its deformation is sufficiently low to maintain the filter material in its elastic region can help ensure retention during such use. Some polymeric filter elements may be bent nearly in half and return to a flat configuration, while a woven metal filter element may be permanently deformed when subjected to the same bending.

Additionally, a metal fuel filter configured to have an interference fit sufficient to retain the filter in the fuel passage and also thick enough to avoid plastic deformation during installation may scrape a wall 46 of the fuel passage as its metal edge slides therealong. The carburetor may be particularly sensitive to contaminants that disrupt metering valve operation, and scraping the fuel passage wall 46 during fuel filter installation may introduce fine particles to the components downstream from the filter 20 before the carburetor is ever in use.

According to one embodiment, the fuel filter 20 has an edge 48 that is polymeric. The polymeric edge 48 may be provided by providing a polymeric filter element 42 as the fuel filter 20 as shown, or by providing a polymeric housing or frame at the edge 48 with any type of filter element 42. The polymeric edge 48 thus slides along the passage wall 46 during filter installation, reducing the likelihood of scraping.

The method may also include cutting the fuel filter element 42 from a sheet 50 of polymeric material. The sheet 50 may be in strip and/or roll form with filter elements 42 successively and individually cut from the strip by a punch or other tool, or the sheet may be sufficiently wide to cut several fuel filter elements 42 from the strip or sheet at once. In the illustrated embodiment, the filter element 42 is cut from the sheet 50 of material so that the resulting filter element 42 is aligned with the fuel passage opening 44 at the time the filter element 42 is cut from the sheet 50. The filter element 42 may subsequently be pressed into the fuel passage 32 and is shown in dashed lines at various positions along the passage 32 during installation. In one embodiment, the same tool is used to cut the filter element 42 from the sheet 50 and to press the filter element through the fuel passage opening 44 and into the fuel passage 32. Such a configuration, in which the finished fuel filter 20 is installed directly from the sheet 50, may allow for fuel filters to be produced with no handling required between filter production and installation. These illustrative methods may of course include additional steps or may be performed with certain steps omitted.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A carburetor, comprising:
a fuel inlet;
a metering system having a metering valve arranged downstream from the fuel inlet; and
a non-metallic filter element supported in a fuel passage of the carburetor.

2. The carburetor of claim 1, wherein the filter element comprises a polymeric material.

3. The carburetor of claim 1, wherein the filter element is constructed from a polyamide, a fluoropolymer, a polyester, a polyacetal, a polyethylene, or an alloy or copolymer thereof.

4. The carburetor of claim 1, wherein the filter element is constructed from a woven material.

5. The carburetor of claim 1, wherein the filter element is constructed from a non-woven material.

6. The carburetor of claim 1, wherein the filter element is a film with a plurality of pores formed therethrough.

7. A method of making a carburetor, comprising the steps of:
providing a substantially flat fuel filter sized to have an interference fit with a fuel passage opening of the carburetor; and
pressing the fuel filter into the opening, wherein the fuel filter is substantially not plastically deformed by the interference fit.

8. The method of claim 7, wherein the step of providing the fuel filter comprises:
cutting a fuel filter element from a sheet of polymeric material.

9. The method of claim 8, wherein the filter element is the filter and the step of cutting is performed so that the filter element is aligned with the opening at the time it is cut from the strip of material.

10. The method of claim 7, wherein a polymeric edge of the fuel filter slides along a wall of the fuel passage during the step of pressing.
